(19) United States
(12) Patent Application Publication
(10) Pub. No.: US 2021/0126718 A1
(43) Pub. Date: Apr. 29, 2021

(54) WAVEFORM CORRECTION APPARATUS, WAVEFORM CORRECTION METHOD, AND INFORMATION PROCESSING SYSTEM

(71) Applicant: FUJITSU LIMITED, Kawasaki-shi (JP)

(72) Inventors: Hiroyuki Tatsukawa, Fukuoka (JP); Hiroshi Yoshida, Fukuoka (JP); KOUICHI MAEDA, Onojo (JP)

(73) Assignee: FUJITSU LIMITED, Kawasaki-shi (JP)

(21) Appl. No.: 17/074,675

(22) Filed: Oct. 20, 2020

(30) Foreign Application Priority Data
Oct. 24, 2019 (JP) 2019-193399

(51) Int. Cl. H04B 14/02

(52) U.S. Cl. CPC H04B 14/023; H04L 25/03853

(57) ABSTRACT

A waveform correction apparatus includes a receiver configured to receive a first signal and a second signal from a signal transmission apparatus, the first signal being a PAM4 signal having a data pattern of a bit array in which gray coding is performed, and the second signal being a PAM4 signal having a data pattern of a bit array in which the gray coding is not performed, and a processor coupled to the receiver and configured to adjust a number of taps in an equalizer based on a difference between correct count values of forward error correction performed on the respective data patterns of the first signal and the second signal.

### CROSS-REFERENCE TO RELATED APPLICATION

This application is based upon and claims the benefit of priority of the prior Japanese Patent Application No. 2019-193399, filed on Oct. 24, 2019, the entire contents of which are incorporated herein by reference.

### FIELD

The embodiment discussed herein are related to a waveform correction apparatus, a waveform correction method, and an information processing system.

### BACKGROUND

In recent years, a four-level pulse amplitude modulation scheme (also referred to as PAM4 below) has been introduced as the next-generation communication interface method. PAM4 is a scheme of modulating two-bit data into a signal (also referred to as a PAM4 signal below) having amplitudes of four levels by mapping the data into one symbol.

In communication using such a PAM4 signal (also referred to as PAM4 communication below), gray coding is generally performed on the generated PAM4 signal. Thus, in the PAM4 communication, it is possible to reduce a read error between levels of bit arrays adjacent to each other to one bit (for example, see Japanese Laid-open Patent Publication Nos. 2016-136728 and 2010-505364).

### SUMMARY

According to an aspect of the embodiments, a waveform correction apparatus includes a receiver configured to receive a first signal and a second signal from a signal transmission apparatus, the first signal being a PAM4 signal having a data pattern of a bit array in which gray coding is performed, and the second signal being a PAM4 signal having a data pattern of a bit array in which the gray coding is not performed, and a processor coupled to the receiver and configured to adjust a number of taps in an equalizer based on a difference between correct count values of forward error correction performed on the respective data patterns of the first signal and the second signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating signal modulation in PAM4;

FIG. 2 is a diagram illustrating the signal modulation in PAM4;

FIG. 3 is a diagram illustrating a comparison between PAM4 and NRZ;

FIG. 4 is a diagram illustrating the comparison between. PAM4 and NRZ;

FIG. 5 is a diagram illustrating clock skew between drivers;

FIG. 6A is diagram illustrating the clock skew between drivers;

FIG. 6B is diagram illustrating the clock skew between drivers;

FIG. 7 is a diagram illustrating a configuration of an information processing system;

FIG. 8 is a diagram illustrating functions of the information processing system;

FIG. 9 is a diagram illustrating functions of the information processing system;

FIG. 10 is a flowchart illustrating operations of a transceiver and a receiver in an embodiment;

FIG. 11 is a flowchart illustrating the operations of the transceiver and the receiver in the embodiment;

FIG. 12 is a flowchart illustrating the operations of the transceiver and the receiver in the embodiment;

FIG. 13 is a flowchart illustrating the operations of the transceiver and the receiver in the embodiment;

FIG. 14 is a flowchart illustrating the operations of the transceiver and the receiver in the embodiment;

FIG. 15 is a diagram illustrating a specific example of a timer setting value;

FIG. 16 is a diagram illustrating a threshold in a waveform of a PAM4 signal;

FIG. 17 is a diagram illustrating a specific example of a histogram of the waveform of the PAM4 signal;

FIG. 18 is a diagram illustrating a specific example of a correction table; and

FIG. 19 is a diagram illustrating a specific example of calculating an SNR.

### DESCRIPTION OF EMBODIMENTS

In the related art, the waveform of the PAM4 signal includes three eye openings. Therefore, in PAM4 communication, the level determination threshold width is significantly narrower than in the case of communication using a two-level NRZ (Non-Return-to-Zero) signal, and level determination on the receiver side becomes difficult.

Therefore, in PAM4 communication, forward error correction (FEC: Forward Error Correction) is generally introduced. As a result, in PAM4 communication, it becomes possible to hold an errorless waveform.

However, when FEC is introduced, power consumption associated with PAM4 communication increases. Therefore, in this case, there arises a problem that efficient communication cannot be performed.

Therefore, in one aspect, an object of the disclosure is to provide a waveform correction device, a waveform correction method, and a waveform correction system that enable efficient communication while maintaining communication quality.

Hereinafter, an embodiment of the disclosure will be described with reference to the drawings. The embodiment does not limit the technical scope of the disclosure.

[Signal Modulation in PAM4]

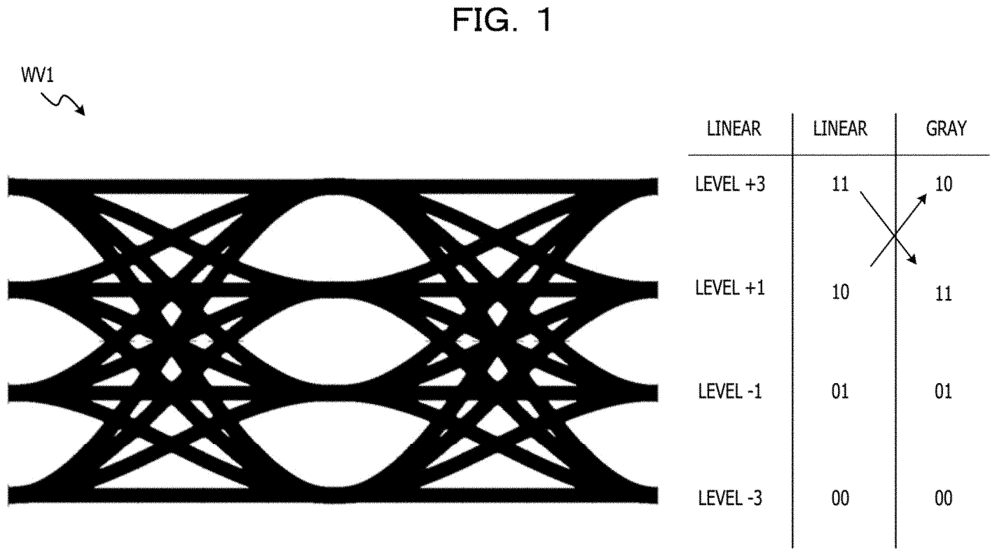

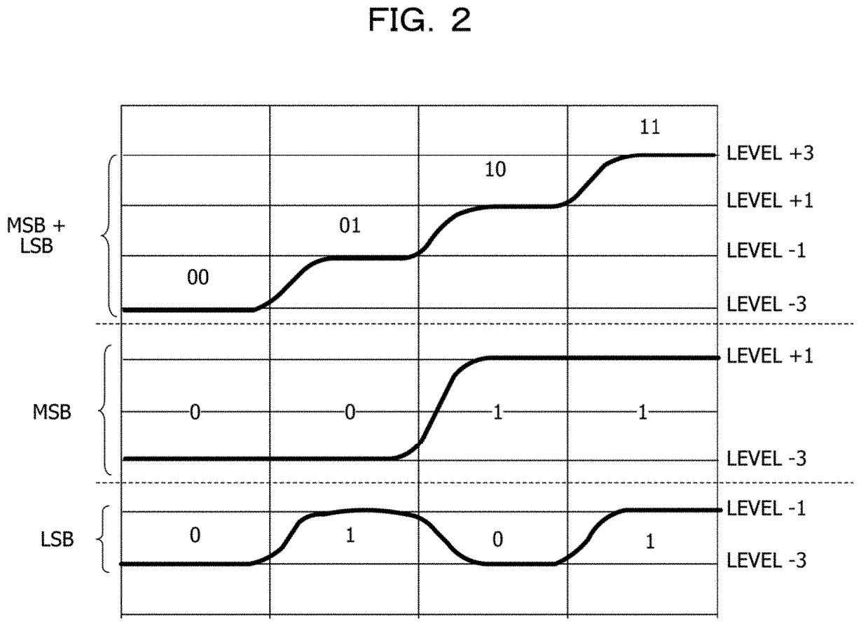

Firstly, signal modulation in PAM4 will be described. FIGS. 1 and 2 are diagrams illustrating signal modulation in PAM4.

A PAM4 signal is a signal in which two-bit data is mapped on one symbol. Therefore, in a case of most significant bit (MSB) first, for example, the PAM4 signal is modulated to have amplitudes of four levels being Level−3, Level−1, Level+1, and Level+3, as illustrated in a waveform WV1 (left side) in FIG. 1.

When the bits are linearly arranged, bit arrays corresponding to Level−3, Level−1, Level+1, and Level+3 are “00”, “01”, “10”, and “11”, respectively, Regarding this, in PAM4, gray coding is performed on a bit string in which bits are linearly arranged, and thereby “11” and “10” are obtained as the bit arrays corresponding to Level+1 and Level+3, as illustrated in the table (right side) in FIG. 1. Thus, in PAM4, it is possible to reduce a read error between levels of bit arrays adjacent to each other to one bit.

The PAM4 signal is formed, for example, by combining the MSB and the least significant bit (LSB). For example, as illustrated in FIG. 2, in PAM4, a PAM4 signal having four levels (waveform on the top in FIG. 2) is formed in a manner that the amplitude of the MSB (waveform in the middle of FIG. 2) is set to two times the amplitude of the LSB (waveform in the bottom of FIG. 2), and then the MSB and the LSB are combined.

[Comparison Between PAM4 and NRZ]

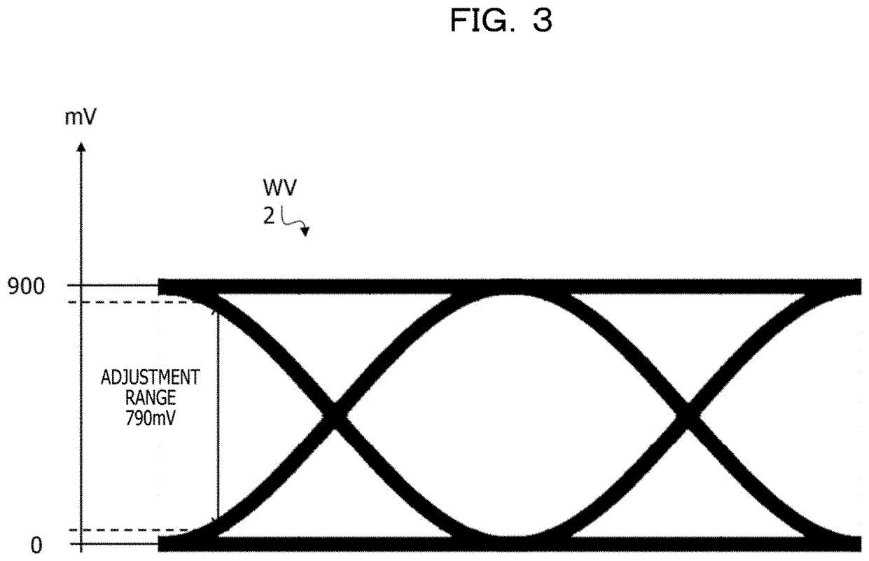

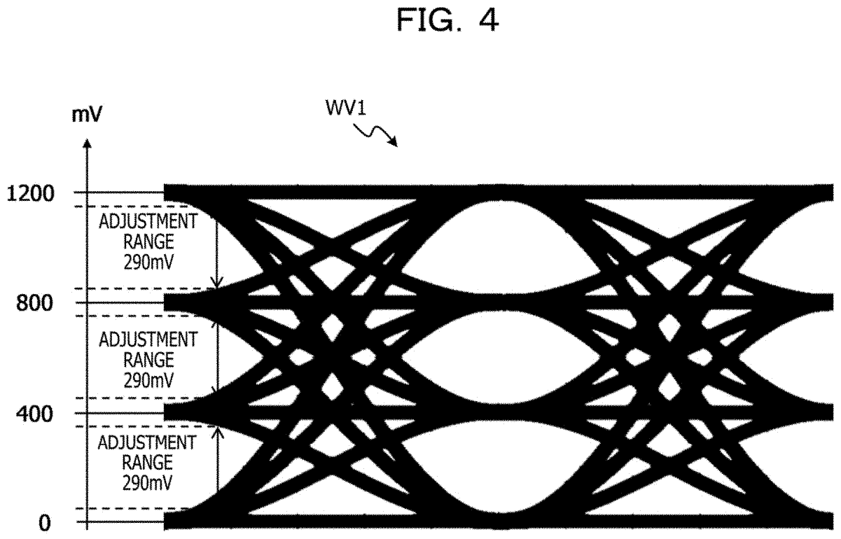

Next, a comparison between PAM4 and NRZ will be described. FIGS. 3 and 4 are diagrams illustrating a comparison between PAM4 and NRZ. For example, FIG. 3 is a diagram illustrating a level determination threshold width in the waveform of an NRZ signal. FIG. 4 is a diagram illustrating the level determination threshold width in the waveform of a PAM4 signal.

As illustrated in FIG. 3, only one eye opening appears in a waveform WV2 of an NRZ signal. Therefore, in the waveform WV2, the level determination threshold width allowing level determination on a receiver side to be sufficiently performed is ensured (790 (mV) in the example illustrated in FIG. 3).

On the contrary, as illustrated in FIG. 4, three eye openings appear in the waveform WV1 of a PAM4 signal. Therefore, in the waveform WV1, the level determination threshold width allowing level determination on the receiver side to be sufficiently performed is not ensured (290 (mV) in the example illustrated in FIG. 4). The number of levels in the waveform WV1 in PAM4 are more than the number of levels in the waveform WV2 in NRZ. Thus, a signal-to-noise ratio (SNR) is decreased.

Generally, in PAM4 communication, forward error correction (FEC) is introduced. Thus, in PAM4 communication, it is possible to hold an errorless waveform.

However, when FEC is introduced as described above, power consumption by the PAM4 communication increases, and the number of bits to be added also increases. Therefore, in this case, there is a problem that it is not possible to efficiently perform PAM4 communication.

An MSB driver and an LSB driver for forming a PAM4 signal are separate drivers. Therefore, an error in clock timing may occur between the MSB driver and the LSB driver, and clock skew may occur between the drivers.

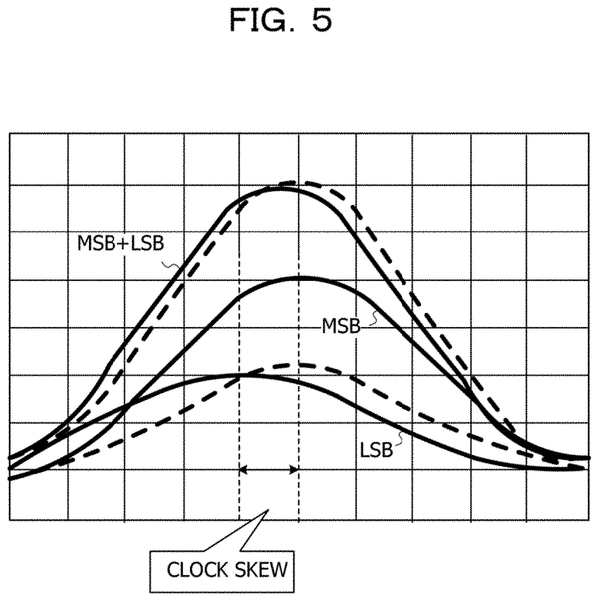

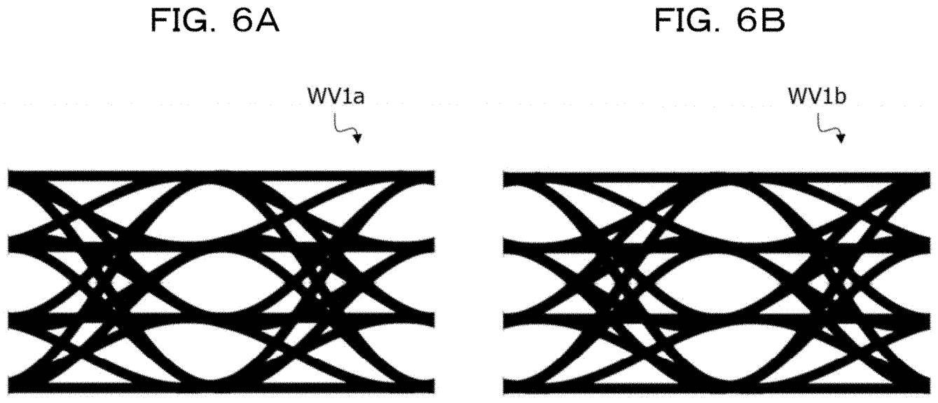

For example, when the clock timing of the LSB driver is earlier than the clock timing of the MSB driver as illustrated in FIG. 5, a waveform WV1a of a PAM4 signal formed by combination is distorted as illustrated in FIG. 6A. For example, when the clock timing of the LSB driver is later than the dock timing of the MSB driver, a waveform WV1b of a PAM4 signal formed by combination is distorted as illustrated in FIG. 6B.

A waveform correction function mounted in an equalizer on the receiver side is generally a function of performing correction by using a correction counter in FEC. Therefore, in PAM4 communication in which there are three eye openings, it is difficult to perform adjustment in accordance with the state of each eye opening.

In the embodiment, the receiver alternately receives a PAM4 signal (also referred to as a first signal below) having a data pattern of a bit array in which gray coding is performed, and a PAM4 signal (also referred to as a second signal below) having a data pattern of a bit array (linear bit array) in which the gray coding is not performed, from a transceiver.

In the embodiment, the receiver adjusts the number of taps in the equalizer, based on a difference between correct count values in FEC performed on the respective data patterns of the first signal and the second signal.

For example, in the embodiment, when waveform correction of a PAM4 signal is performed, the transceiver alternately transmits the first signal having a data pattern of a bit array in which gray coding is performed, and the second signal having a data pattern of a linear bit array. In the embodiment, the receiver determines the distortion state of the current waveform by comparing the correct count value during transmission of the first signal with the correct count value during transmission of the second signal, and adjusts the number of taps in the equalizer to be increased or decreased in accordance with the determination result.

Thus, in the embodiment, the receiver may suppress the waveform distortion of a PAM4 signal while reducing the number of taps in the equalizer to the desired minimum. Therefore, the receiver may perform efficient communication while maintaining communication quality.

[Configuration of Information Processing System]

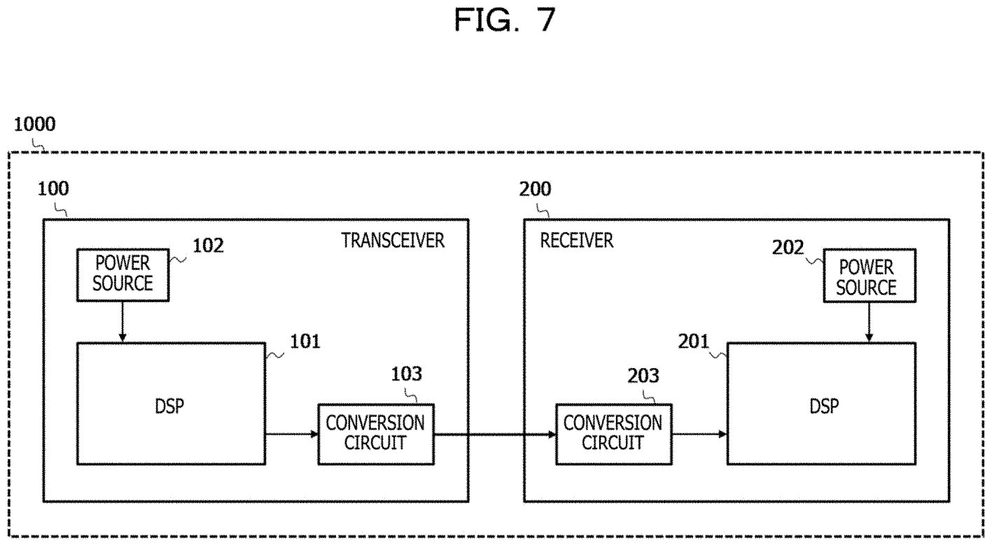

Next, a configuration of an information processing system 1000 in the embodiment will be described. FIG. 7 is a diagram illustrating the configuration of the information processing system 1000.

The information processing system 1000 (also referred to as a waveform correction system 1000 below) includes a transceiver 100 and a receiver 200 as illustrated in FIG. 7. The transceiver 100 (also referred to as a signal transmission apparatus 100 below) is an apparatus that generates and transmits a PAM4 signal. The receiver 200 (also referred to as a waveform correction apparatus 200 below) is an apparatus that receives and analyzes the PAM4 signal.

In the example illustrated in FIG. 7, the transceiver 100 includes a digital signal processor (DSP) 101, a power source 102, and a conversion circuit 103.

The DSP 101 is a processor configured to execute various processes for generating and transmitting a PAM4 signal.

The conversion circuit (also referred to as a transmitting unit below) 103 is a circuit including a serializer/deserializer (SerDes) and an optical module, for example.

In the example illustrated in FIG. 7, the receiver 200 includes a DSP 201, a power source 202, and a conversion circuit 203.

The DSP (also referred to as an adjusting unit below) 201 is a processor configured to execute various processes by receiving the PAM4 signal.

The conversion circuit (also referred to as a receiving unit below) 203 is a circuit including, for example, a serializer deserializer (SerDes) and an optical module, similar to the conversion circuit 103.

[Functions of Information Processing System]

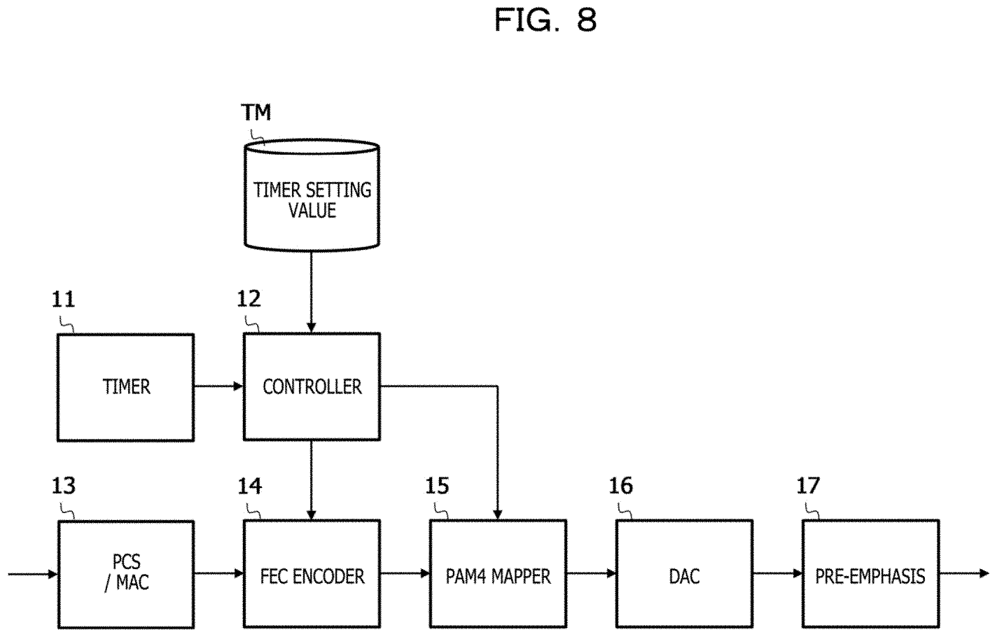

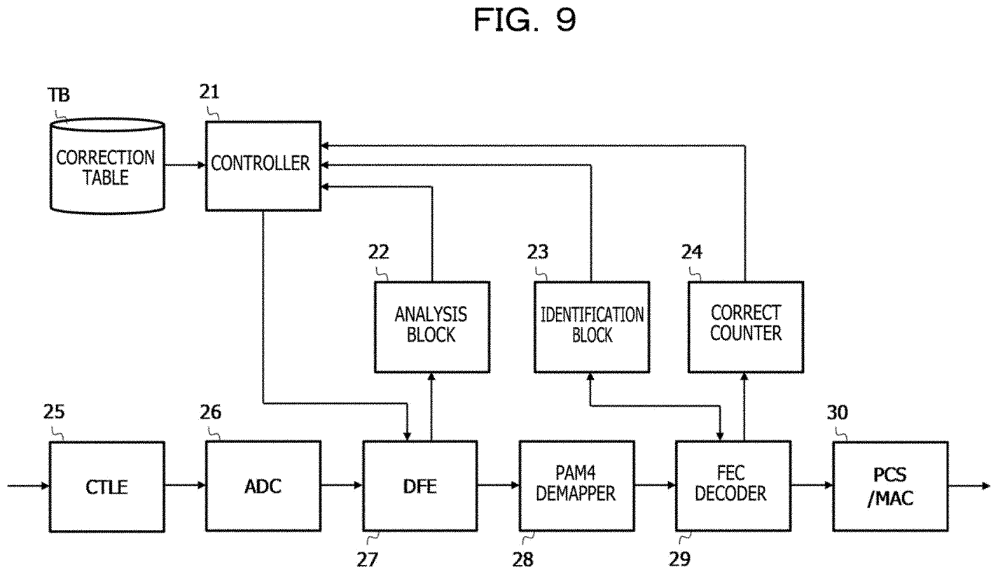

Next, functions of the information processing system 1000 in the embodiment will be described. FIGS. 8 and 9 are diagrams illustrating the functions of the information processing system 1000, For example, FIG. 8 is a diagram illustrating functions of the transceiver 100. FIG. 9 is a diagram illustrating functions of the receiver 200.

Firstly, the functions of the transceiver 100 will be described.

As illustrated in FIG. 8, the transceiver 100 implements various functions including a timer 11, a controller 12, a physical coding sublayer (PCS)/media access control (MAC) 13, an FEC encoder 14, a PAM4 mapper 15, a digital-to-analog converter (DAC) 16, and a pre-emphasis 17, for example. As illustrated in FIG. 8, the transceiver 100 holds a timer setting value TM, for example.

For example, the FEC encoder 14 adds each bit desired for performing FEC to the data pattern generated in the PCS/MAC 13. The FEC encoder 14 adds, to the data pattern generated in the PCS/MAC 13, a flag (bit) for identifying a signal (also referred to as a waveform correction signal below) transmitted in order to perform waveform correction and a signal (also referred to as a normal operation signal below) transmitted in a normal operation, and a flag (bit) indicating whether or not the waveform correction signal to be transmitted is any one of the first signal and the second signal.

The PAM4 mapper 15 is a function including an MSB driver (not illustrated) and an LSB driver (not illustrated), For example, the MSB driver and the LSB driver generate an MSB signal and an LSB signal from the data pattern to which the bits are added by the FEC encoder 14, respectively. The PAM4 mapper 15 generates a PAM4 signal from the generated MSB signal and LSB signal.

The DAC 16 converts the PAM4 signal (digital signal) generated by the PAM4 mapper 15 into an analog signal.

The pre-emphasis 17 shapes the waveform of the PAM4 signal converted by the DAC 16.

The controller 12 issues an instruction indicating which signal among the first signal and the second signal starts to be transmitted, to each of the FEC encoder 14 and the PAM4 mapper 15.

The timer 11 issues an instruction indicating transmission intervals and the number of transmissions of the first signal and the second signal, to the controller 12. For example, the timer 11 issues the instruction indicating the transmission intervals and the number of transmissions of the first signal and the second signal by referring to information set in the timer setting value TM.

Next, the functions of the receiver 200 will be described.

As illustrated in FIG. 9, the receiver 200 implements various functions including a controller 21, an analysis block 22, an identification block 23, a correct counter 24, a continuous time linear equalizer (CTLE) 25, an analog-to-digital converter (ADC) 26, a decision feedback equalizer (DFE) 27, a PAM4 demapper 28, an FEC decoder 29, and a PCS/MAC 30, for example. As illustrated in FIG. 9, the receiver 200 holds a correction table TB (also referred to as correspondence information below), for example.

For example, the CUE 25 shapes the waveform of the PAM4 signal received from the transceiver 100.

The ADC 26 converts the PAM4 signal (analog signal) having the waveform shaped by the CTLE 25 into a digital signal.

The DFE 27 (also referred to as an equalizer 27 below) shapes the waveform of the PAM4 signal converted by the ADC 26.

The PAM4 demapper 28 restores the PAM4 signal having a waveform shaped by the equalizer 27 into an MSB signal and an LSB signal.

The FEC decoder 29 performs FEC on the MSB signal and the LSB signal obtained through restoration by the PAM4 demapper 28.

For example, the FEC decoder 29 performs FEC on each of the MSB signal and the LSB signal by referring to a bit corresponding to FEC among bits included in each of the MSB signal and the LSB signal. The FEC decoder 29 transmits the MSB signal and the LSB signal subjected to FEC to the PCS/MAC 30.

The FEC decoder 29 detects the flag included in each of the MSB signal and the LSB signal obtained through restoration by the PAM4 demapper 28.

The correct counter 24 counts the number (also referred to as the correct count value below) of times of correction being performed in the FEC decoder 29. For example, the correct counter 24 transmits the correct count value to the controller 21 at a regular timing. Details of the operation of the correct counter 24 will be described later.

The analysis block 22 generates a histogram of the waveform of the PAM4 signal, for example, by analyzing the PAM4 signal having the waveform shaped by the DFE 27, The analysis block 22 transmits the generated histogram to the controller 21.

The identification block 23 determines whether or not the PAM4 signal transmitted from the transceiver 100 is a waveform correction signal, with reference to the flag detected by the FEC decoder 29. When the received PAM4 signal is determined to be the waveform correction signal, the identification block 23 further refers to the flag included in the received PAM4 signal and determines which one of the first signal and the second signal the PAM4 signal transmitted from the transceiver 100 is. The identification block 23 transmits the determination result to the controller 21.

The controller 21 determines the number of taps in the equalizer 27 based on the information set in the correction table TB, the correct count value transmitted from the correct counter 24, pieces of information transmitted from the analysis block 22 and the identification block 23. Details of the operations of the controller 21, the analysis block 22, and the identification block 23 will be described later.

[Flowcharts in Embodiment]

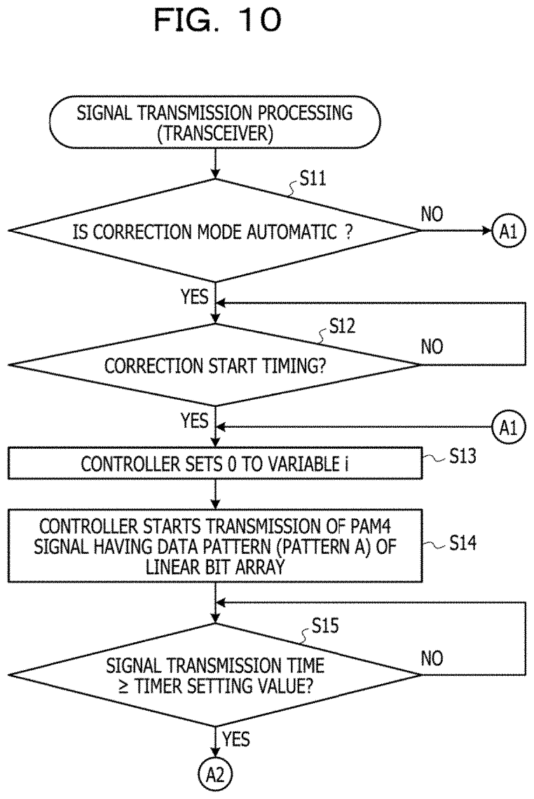

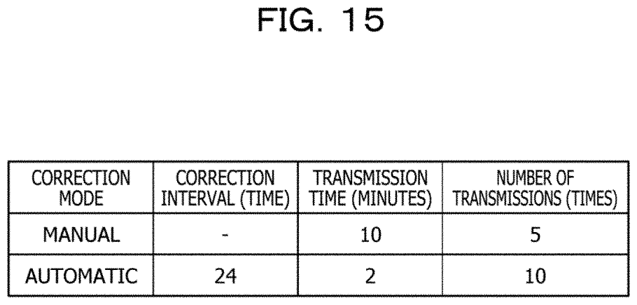

Next, flowcharts in the embodiment will be described. FIGS. 10 to 14 are flowcharts illustrating the operations of the transceiver 100 and the receiver 200 in the embodiment. FIGS. 15 to 19 are diagrams that describe the operations of the transceiver 100 and the receiver 200 in the embodiment.

[Signal Transmission Processing]

Firstly, processing (also referred to as signal transmission processing below) performed in the transceiver 100 will be described.

As illustrated in FIG. 10, the controller 12 determines whether or not a correction mode is automatic (S11). For example, the controller 12 determines whether or not the correction mode designated in advance by a user is automatic.

When the correction mode is determined to be automatic (YES in S11), the controller 12 waits until a correction start timing (NO in S12).

For example, the controller 12 specifies the correction start timing by referring to the timer setting value TM. The controller 12 waits until the specified correction start timing. A specific example of the timer setting value TM will be described below.

[Timer Setting Value]

FIG. 15 is a diagram illustrating the specific example of the timer setting value TM.

The timer setting value TM illustrated in FIG. 15 includes, as items, “correction mode” in which the type of a correction mode is set, “correction interval” in which a correction interval is set, “transmission time” indicating a transmission time per one transmission of the PAM4 signal, and “number of transmissions” indicating the number of repeated transmissions of the PAM4 signal. For example, “automatic” or “manual” is set in “correction mode”. “-” is set in a field in which there is no information.

For example, in information of the first row, “manual” is set as “correction mode”, “-” is set as “correction interval”, “10 (minutes)” is set as “transmission time”, and “5 (times)” is set as “number of transmissions”.

In information of the second row, “automatic” is set as “correction mode”, “24 (hours)” is set as “correction interval”, “2 (minutes)” is set as “transmission time”, and “10 (times)” is set as “number of transmissions”.

For example, the timer setting value TM illustrated in FIG. 15 indicates that, when the correction mode is manual, the transmission time of a PAM4 signal per one transmission is 10 (minutes), and the number of repeated transmissions of the PAM4 signal is 5 (times). The timer setting value TM illustrated in FIG. 15 indicates that, when the correction mode is automatic, waveform correction of a PAM4 signal is performed every 24 hours, the transmission time of the PAM4 signal per one transmission is 2 (minutes), and the number of repeated transmissions of the PAM4 signal is 5 (times).

When the correction mode is manual, waveform correction of the PAM4 signal may be started at a time point designated by the user, for example.

In the process of S12, the controller 12 specifies “24 (h)” set in “correction interval” of information (information of the second row) in which “correction mode” is “automatic”, with reference to the timer setting value TM illustrated in FIG. 15, for example. The controller 12 waits until 24 hours elapses after the previous waveform correction of the PAM4 signal has been performed.

Returning to FIG. 10, when the correction start timing is reached (YES in S12), the controller 12 sets 0 (initial value) to a variable i indicating the number of transmissions of the PAM4 signal (S13). The controller 12 performs the process of S13 similarly in a case (NO in S11) where the correction mode is determined to be manual in the process of S11.

The controller 12 starts transmission of a PAM4 signal (second signal) having a data pattern (also referred to as a pattern A below) of a linear bit array (S14).

Then, the controller 12 waits until the transmission time of the PAM4 signal that has been started to be transmitted in the process of S14 becomes equal to or longer than the time set in the timer setting value TM (NO in S15).

For example, in the timer setting value TM described with reference to FIG. 15, “10 (minutes)” is set in “transmission time” of information (information in the first row) in which “correction mode” is “manual”, and “2 (minutes)” is set in “transmission time” of information (information in the second row) in which “correction mode” is “automatic”. Therefore, when the correction mode is manual, the controller 12 waits until the transmission time of the PAM4 signal that has been started to be transmitted in the process of S14 becomes 10 (minutes). When the correction mode is automatic, the controller 12 waits until the transmission time of the PAM4 signal that has been started to be transmitted in the process of S14 becomes 2 (minutes).

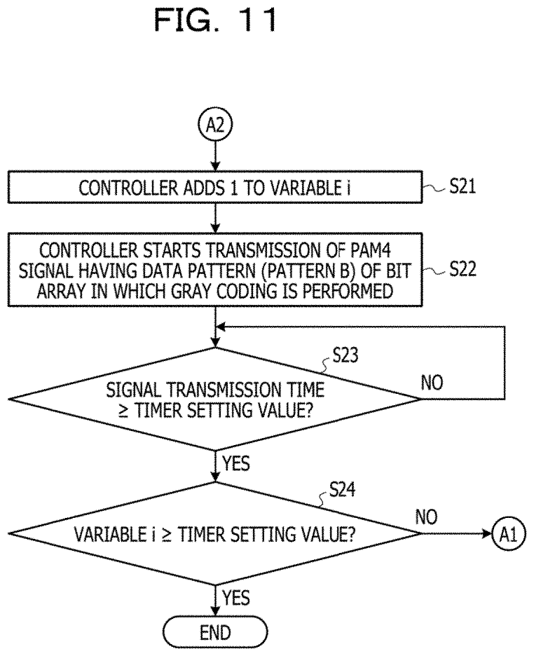

When the transmission time of the PAM4 signal that has been started to be transmitted in the process of S14 becomes equal to or longer than the time set in the timer setting value TM (YES in S15), the controller 12 adds 1 to the value set in the variable i, as illustrated in FIG. 11 (S21).

The controller 12 starts transmission of a PAM4 signal (first signal) having a data pattern (also referred to as a pattern B below) of a bit array in which gray coding is performed (S22).

For example, when one transmission of the PAM4 signal having the pattern A is completed, the controller 12 starts transmission of the PAM4 signal having the pattern B.

Then, the controller 12 waits until the transmission time of the PAM4 signal that has been started to be transmitted in the process of S22 becomes equal to or longer than the time set in the timer setting value TM (NO in S23).

For example, in the timer setting value TM described with reference to FIG. 15, “10 (minutes)” is set in “transmission time” of information (information in the first row) in which “correction mode” is “manual”, and “2 (minutes)” is set in “transmission time” of information (information in the second row) in which “correction mode” is “automatic”. Therefore, when the correction mode is manual, similar to a case of the process of S15, the controller 12 waits until the transmission time of the PAM4 signal that has been started to be transmitted in the process of S22 becomes 10 (minutes). When the correction mode is automatic, similar to a case of the process of S15, the controller 12 waits until the transmission time of the PAM4 signal that has been started to be transmitted in the process of S22 becomes 2 (minutes).

When the transmission time of the PAM4 signal that has been started to be transmitted in the process of S22 becomes equal to or longer than the time set in the timer setting value TM (YES in S23), the controller 12 determines whether or not the value set in the variable i is equal to or more than the value set in the timer setting value TM (S24).

For example, in the timer setting value TM described with reference to FIG. 15, “5 (times)” is set in “number of transmissions” of the information (information in the first row) in which “correction mode” is “manual”, and “10 (times)” is set in “number of transmissions” of the information (information in the second row) in which “correction mode” is “automatic”. Therefore, when the correction mode is manual, the controller 12 waits until the value set in the variable i becomes 5 (times). When the correction mode is automatic, the controller 12 waits until the value set in the variable i becomes 10 (times).

As a result, when the value set in the variable i becomes equal to or more than the value set in the timer setting value TM (YES in S24), the controller 12 ends the signal transmission processing.

When the value set in the variable i is not equal to or more than the value set in the timer setting value TM (NO in S24), the transceiver 100 performs the process of S13 and the subsequent processes again.

[First Waveform Correction Processing]

Next, a part of processing performed in the receiver 200 will be described. For example, processing (also referred to as first waveform correction processing below) for performing waveform correction of the middle eye opening among three eye openings included in the PAM4 signal will be described.

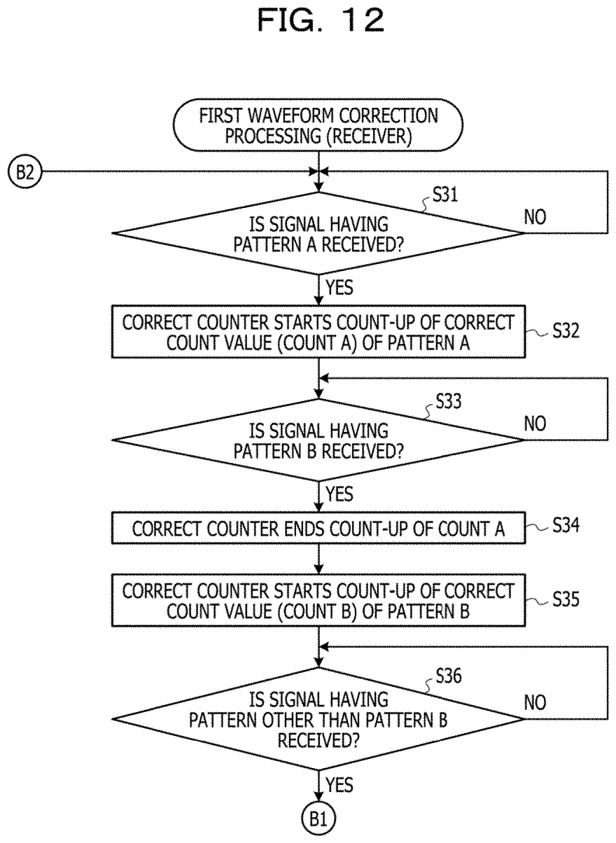

As illustrated in FIG. 12, the identification block 23 wafts until the PAM4 signal having the pattern A is received from the transceiver 100 (NO in S31).

For example, in response to reception of the PAM4 signal transmitted from the transceiver 100, the FEC decoder 29 detects the flag included in the received PAM4 signal. The identification block 23 determines whether or not the received PAM4 signal is a waveform correction signal, with reference to the flag detected by the FEC decoder 29, As a result, when the received PAM4 signal is determined to be the waveform correction signal, the identification block 23 further refers to the flag included in the received PAM4 signal and determines whether or not the received PAM4 signal is the signal having the pattern A.

When the PAM4 signal having the pattern A is received from the transceiver 100 (YES in S31), the correct counter 24 starts count-up of the correct count value (also referred to as count A below) of the pattern A (S32).

For example, when the identification block 23 determines that the received PAM4 signal is the signal having the pattern A, the correct counter 24 starts count-up of the count A.

Then, the identification block 23 waits until the PAM4 signal having the pattern B is received from the transceiver 100 (NO in S33).

For example, the identification block 23 waits until the pattern of the PAM4 signal transmitted from the transceiver 100 is switched from the pattern A to the pattern B.

When the PAM4 signal having the pattern B is received from the transceiver 100 (YES in S33), the correct counter 24 ends the count-up of the count A (S34). In this case, the correct counter 24 transmits the count A to the controller 21.

The correct counter 24 starts count-up of the correct count value (also referred to as count B below) of the pattern B (S35).

Then, the identification block 23 waits until a PAM4 signal having a pattern other than the pattern B is received from the transceiver 100 (NO in S36). For example, the identification block 23 waits until the PAM4 signal received from the transceiver 100 is determined to be a signal having the pattern A or the normal operation signal.

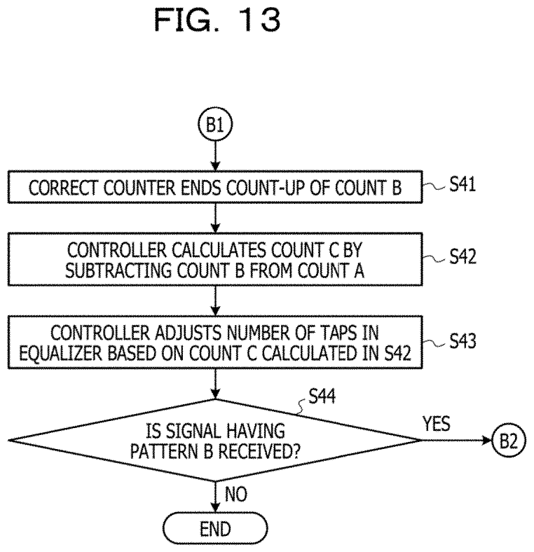

When the PAM4 signal having a pattern other than the pattern B is received from the transceiver 100 (YES in S36), the correct counter 24 ends the count-up of the count B as illustrated in FIG. 13 (S41). In this case, the correct counter 24 transmits the count B to the controller 21.

The controller 21 calculates a count C by subtracting the count. B from the count A (S42). Details of the process of S42 will be described below.

[Details of Process of S42]

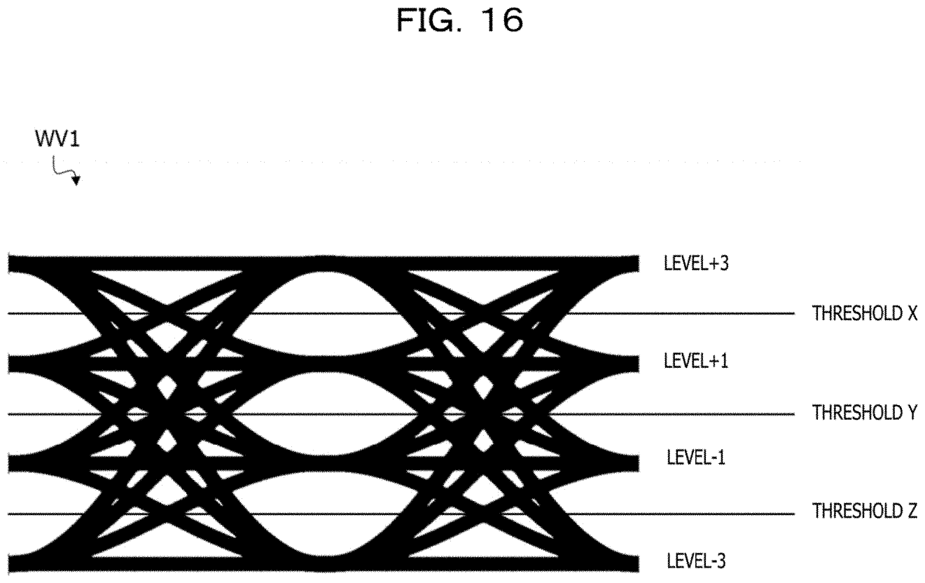

FIG. 16 is a diagram illustrating a threshold in a waveform of a PAM4 signal.

As illustrated in FIG. 16, when the correct count value is counted for each of a threshold X, a threshold Y, and a threshold Z, the count A and the count B are expressed by the following expressions (1) and (2). Descriptions will be made below on the assumption that the correct count values for the threshold X, the threshold Y, and the threshold Z are x, y, and z, respectively.

x+2y+z=Count A (1)

x+y+z=Count B (2)

For example, in a PAM4 signal (first signal) having a data pattern of a bit array in which gray coding is performed, all read errors between the levels of the bit arrays adjacent to each other are one bit. However, in a PAM4 signal (second signal) having a data pattern of a linear bit array, a read error between Level−1 and Level+1 is two bits. Therefore, the second term on the left side is different between the above expressions (1) and (2).

Therefore, the controller 21 calculates the value calculated by subtracting the count B from the count A, as the count C in the process of S42.

For example, the controller 21 calculates, as the count C, y which is the correct count value of the threshold Y corresponding to the middle eye opening among the three eye openings included in the waveform of the PAM4 signal.

Returning to FIG. 13, the controller 21 adjusts the number of taps in the equalizer based on the count C calculated in the process of S42 (S43).

For example, the controller 21 compares the count C to each of a threshold A and a threshold B determined in advance by the manufacturer evaluation or the like. The threshold A may be, for example, the maximum correct count value allowing the quality of the middle eye opening among the three eye openings included in the waveform of a PAM4 signal. The threshold B may be, for example, the minimum correct count value causing the quality of the middle eye opening not to become excessive quality.

For example, when the threshold A<the count C, the controller 21 transmits an instruction to increase the number of taps to be operated by one, to the equalizer 27. For example, when the count C<the threshold B, the controller 21 transmits an instruction to decrease the number of taps to be operated by one, to the equalizer 27.

Thus, the receiver 200 may suppress the waveform distortion of the middle eye opening while reducing the number of taps in the equalizer 27 to the desired minimum.

Then, the identification block 23 determines whether or not the PAM4 signal received from the transceiver 100 is a signal having the pattern B (S44).

As a result, when the PAM4 signal received from the transceiver 100 is determined to be the signal having the pattern B (YES in S44), the receiver 200 performs the process of S31 and the subsequent processes again.

When the PAM4 signal received from the transceiver 100 is determined to be the normal operation signal (NO in S44), the receiver 200 ends the first waveform correction processing.

[Second Waveform Correction Processing]

Next, another part of processing performed in the receiver 200 will be described. For example, processing (also referred to as second waveform correction processing below) for performing waveform correction of two eye openings (upper and lower eye openings) among three eye openings included in a PAM4 signal will be described.

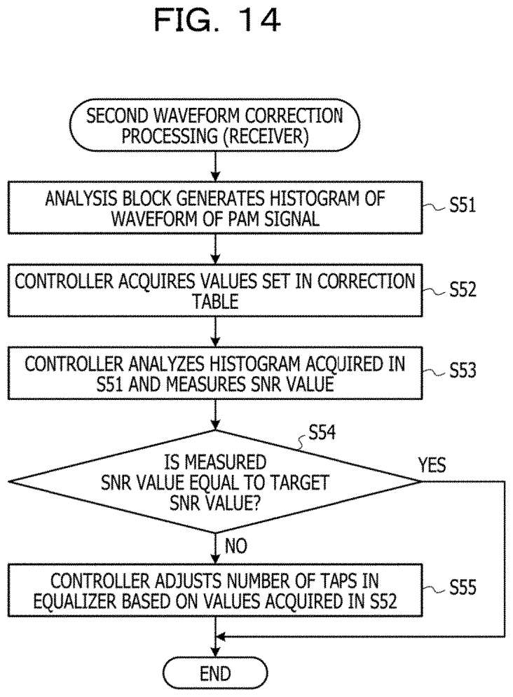

As illustrated in FIG. 14, the analysis block 22 generates a histogram of the waveform of the PAM4 signal transmitted from the transceiver 100, at a predetermined timing (S51). For example, the analysis block 22 may perform the process of S51 and the subsequent processes in response to completion of the first waveform correction processing described with reference to FIGS. 12 and 13.

The middle eye opening of the waveform of a PAM4 signal is mainly affected by the slope of the MSB along in the waveform transition of the MSB alone, and is not affected by the clock skew between the MSB driver and the LSB driver. Therefore, the analysis block 22 generates a histogram based on the middle eye opening as a reference, in the process of S51.

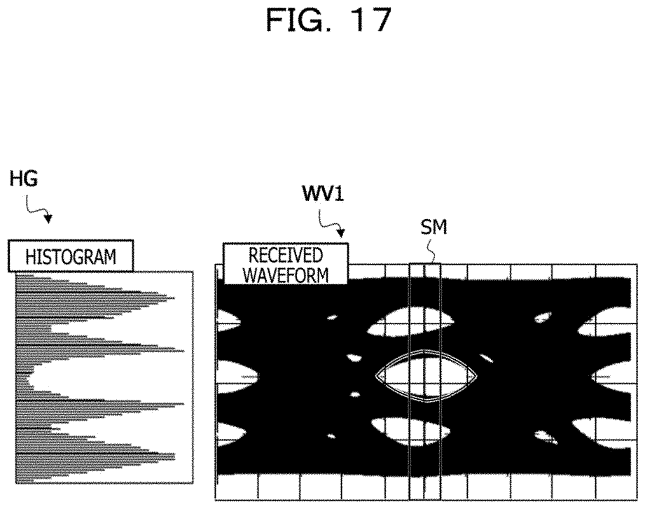

For example, as illustrated on the right side of FIG. 17, the analysis block 22 specifies the signal intensity of a sample SM in the waveform WV1 for each predetermined voltage range. As illustrated on the left side of FIG. 17, the analysis block 22 generates a histogram HG corresponding to each specified signal intensity, based on the signal intensity in the middle eye opening as a reference.

Returning to FIG. 14, the controller 21 acquires values set in the correction table TB (S52). A specific example of the correction table TB will be described below.

[Correction Table]

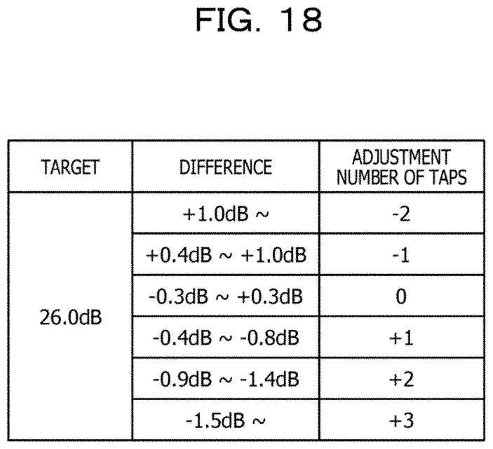

FIG. 18 is a diagram illustrating the specific example of the correction table TB.

The correction table TB illustrated in FIG. 18 includes, as items, “target” in which an SNR value serving as a target (also referred to as target SNR value below) is set, “difference” in which a difference between a measured SNR value and the target. SNR value is set, and “adjustment number of taps” in which the adjustment number of taps (also referred to as a change value below) is set.

For example, “26.0 (dB)” is set in “target” the correction table TB illustrated in FIG. 18.

In the first row of the correction table TB illustrated in FIG. 18, “+1.0 (dB) to” is set as “difference”, and “−2” is set as “adjustment number of taps”.

In the second row of the correction table TB illustrated in FIG. 18, “+0.4 (dB) to +1.0 (dB)” is set as “difference”, and “−1” is set as “adjustment number of taps”. Descriptions of other information included in FIG. 18 will be omitted.

Returning to FIG. 14, the controller 21 analyzes the histogram acquired in the process of S51 and measures the SNR value (measured SNR value) (S53).

The controller 21 determines whether or not the measured SNR value measured in the process of S53 is equal to the target SNR value (S54).

For example, “26.0 (dB)” is set in “target” in the correction table TB described in FIG. 18. Therefore, for example, the controller 21 determines whether or not the measured SNR value measured in the process of S53 is 26.0 (dB).

In this case, the controller 21 may determine whether the measured SNR value measured in the process of S53 is 26.0±α (dB).

As a result, when it is determined that the measured SNR value measured in the process of S53 is not equal to the target SNR value (NO in S54), the controller 21 adjusts the number of taps in the equalizer 27 based on the value acquired in the process of S52 (S55). The receiver 200 ends the second waveform correction processing. Details of the process of S55 will be described below.

[Details of Process of S55]

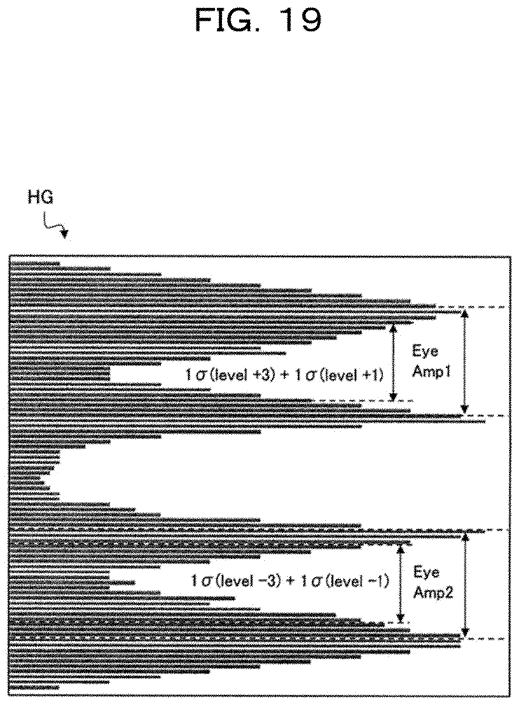

FIG. 19 is a diagram illustrating a specific example of calculating an SNR.

The controller 21 refers to the histogram acquired in the process of S51, and calculates, for example, “1σ (Level+3)+1σ (Level+1)” and “EyeAmp1” as illustrated in FIG. 19. The controller 21 calculates the SNR by dividing the calculated “EyeAmp1” by “1σ (Level+3)+1σ (Level+1)”.

As illustrated in FIG. 19, the controller 21 may calculate “1σ (Level−3)+1σ (Level−1)” and “EyeAmp2”, for example. The controller 21 may calculate the SNR by dividing the calculated “EyeAmp2” by “1α (Level−3)+1α (Level−1)”.

The controller 21 refers to the values acquired in the process of S52 and specifies the adjustment number of taps corresponding to the SNR.

For example, in the correction table TB described with reference to FIG. 18, “+2” is set in “adjustment number of taps” of information (information in the fifth row) in which “−0.9 (dB) to −1.4 (dB)” is set in “difference”. “26.0 (dB)” is set in “target” in the correction table I B described in FIG. 18. Therefore, for example, when the calculated SNR is “25.0 (dB)”, the controller 21 subtracts “26.0 (dB)” from “25.0 (dB)”, and thus calculates “−1.0 (dB)” as “difference”. The controller 21 refers to the values acquired in the process of S52 (values included in the correction table TB described with reference to FIG. 18), and specifies “+2” as “adjustment number of taps” when “difference” is “−1.0 (dB)”. Then, the controller 21 transmits an instruction to increase the number of taps to be operated by two, to the equalizer 27.

Thus, the receiver 200 may suppress the waveform distortion of the two eye openings (upper and lower eye openings) while reducing the number of taps in the equalizer 27 to the desired minimum.

In the example illustrated in FIG. 19, for example, the controller 21 may adjust the number of taps in accordance with the SNR calculated using “1σ (Level+3)+1σ (Level+1)” and “EyeAmp1”, and adjust the number of taps in accordance with the SNR calculated using “1σ (Level−3)+1σ(Level−1)” and “EyeAmp2”.

For example, the controller 21 may adjust the number of taps in accordance with the SNR calculated using “1σ (Level+3)+1σ (Level+1)” and “EyeAmp1”, and then further adjust the number of taps in accordance with the SNR calculated using “1σ (Level−3)+1a (Level−1)” and “EyeAmp2”.

Returning to FIG. 14, when it is determined that the measured SNR value measured in the process of S53 is equal to the target SNR value (YES in S54), the controller 21 does not perform the process of S55.

For example, in this case, the controller 21 determines that it is not desired to perform the waveform correction for the two eye openings (upper and lower eye openings) among the three eye openings included in the waveform of a PAM4 signal.

As described above, in the embodiment, the receiver 200 alternately receives, from the transceiver 100, the PAM4 signal (first signal) having a data pattern of a bit array in which gray coding is performed, and the PAM4 signal (second signal) having a data pattern of a linear bit array.

In the embodiment, the receiver 200 adjusts the number of taps in the equalizer 27, based on the difference between the correct count values in FEC performed on the respective data patterns of the first signal and the second signal.

For example, in the embodiment, when waveform correction of a PAM4 signal is performed, the transceiver 100 alternately transmits the first signal having a data pattern of a bit array in which gray coding is performed, and the second signal having a data pattern of a linear bit array. In the embodiment, the receiver 200 determines the distortion state of the current waveform by comparing the correct count value during transmission of the first signal with the correct count value during transmission of the second signal, and determines the number of taps in the equalizer 27 to be increased or decreased in accordance with the determined distortion state.

Thus, in the embodiment, the receiver 200 may suppress the waveform distortion of a PAM4 signal while reducing the number of taps in the equalizer 27 to the desired minimum. Therefore, the receiver 200 may perform efficient communication while maintaining communication quality.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A waveform correction apparatus comprising:
a receiver configured to receive a first signal and a second signal from a signal transmission apparatus, the first signal being a PAM4 signal having a data pattern of a bit array in which gray coding is performed, and the second signal being a PAM4 signal having a data pattern of a bit array in which the gray coding is not performed; and
a processor coupled to the receiver and configured to adjust a number of taps in an equalizer based on a difference between correct count values of forward error correction performed on the respective data patterns of the first signal and the second signal.

2. The waveform correction apparatus according to claim 1, wherein
the processor performs adjustment to increase the number of taps when the difference is greater than a first threshold.

3. The waveform correction apparatus according to claim 1, wherein
the processor performs adjustment to reduce the number of taps when the difference is smaller than a second threshold.

4. The waveform correction apparatus according to claim 1, wherein the processor is configured to:
correct a waveform for an eye opening located at a center among three eye openings in the PAM4 signal by adjusting the number of taps,
calculate a signal-to-noise ratio of either of two eye openings located on top and bottom among the three eye openings, by using the corrected waveform as a reference, and
adjust the number of taps based on the calculated signal-to-noise ratio.

5. The waveform correction apparatus according to claim 4, further comprising:
a memory configured to store correspondence information, wherein
the processor is configured to:
refer to the correspondence information to specify a change value corresponding to the signal-to-noise ratio, and
adjust the number of taps such that the number of taps corresponds to the change value.

6. A waveform correction method, comprising:
receiving a first signal and a second signal from a signal transmission apparatus, the first signal being a PAM4 signal having a data pattern of a bit array in which gray coding is performed, and the second signal being a PAM4 signal having a data pattern of a bit array in which the gray coding is not performed; and
adjusting a number of taps in an equalizer based on a difference between correct count values of forward error correction performed on the respective data patterns of the first signal and the second signal.

7. The waveform correction method according to claim 6, wherein the adjusting includes:
correcting a waveform for an eye opening located at a center among three eye openings in the PAM4 signal by adjusting the number of taps,
calculating a signal-to-noise ratio of either of two eye openings located on top and bottom among the three eye openings by using the corrected waveform as a reference, and
further adjusting the number of aps based on the calculated signal-to-noise ratio.

8. The waveform correction method according to claim 7, wherein the adjusting includes:
specifying a change value corresponding to the signal-to-noise ratio by referring to correspondence information stored in a memory, and
further adjusting the number of taps such that the number of taps corresponds to the change value.

9. An information processing system comprising:
a transceiver configured to transmit a PAM4 signal; and
a receiver configured to receive the PAM4 signal transmitted by the transceiver, wherein
the transceiver transmits a first signal and a second signal to the receiver, the first signal being a PAM4 signal having a data pattern of a bit array in which gray coding is performed, and the second signal being a PAM4 signal having a data pattern of a bit array in which the gray coding is not performed, and
the receiver receives the first signal and the second signal from the transceiver, and adjusts a number of taps in an equalizer based on a difference between correct count values of forward error correction performed on the respective data patterns of the first signal and the second signal.

10. The information processing system according to claim 9, wherein the receiver is configured to:
correct a waveform for an eye opening located at a center among three eye openings in the PAM4 signal by adjusting the number of taps,
calculate a signal-to-noise ratio of either of two eye openings located on top and bottom among the three eye openings, by using the corrected waveform as a reference, and
further adjust the number of aps based on the calculated signal-to-noise ratio.

11. The information processing system according to claim 10, wherein the receiver is configured to:
store correspondence information,
refer to the correspondence information to specify a change value corresponding to the signal-to-noise ratio, and
adjust the number of taps such that the number of taps corresponds to the change value.
